(19) United States
(12) Patent Application Publication
(10) Pub. No.: US 2021/0392961 A1
(43) Pub. Date: Dec. 23, 2021

(54) Collapsible Social Distancing Device

(71) Applicant: Brad Shallit, Ball Ground, GA (US)

(72) Inventor: Brad Shallit, Ball Ground, GA (US)

(21) Appl. No.: 17/345,638

(22) Filed: Jun. 11, 2021

Related U.S. Application Data
(60) Provisional application No. 63/040,149, filed on Jun. 17, 2020.

(51) Int. Cl. A41D 3/00

(52) U.S. Cl. CPC A41D 3/00

(57) ABSTRACT

This present invention relates to a collapsible social distancing device for creating a physical barrier around a wearer of the device. More specifically, the social distancing device is an expandable and collapsible device that can be worn by a wearer on any part of the body. The device preferably provides a six feet radius barrier to indicate the social distancing principle and utilizes a foam construction to prevent any injury or damage to another user bumping into the social distancing device. The device includes a loop opening, a bottom circular barrier and a plurality of connecting arms attached to the loop opening and the bottom circular barrier. The device has mechanical or electronic means to reduce the diameter of the circular barrier and can be carried in a bag when not being used by the wearer for indicating social distance limitations.

### CROSS-REFERENCE TO RELATED APPLICATION

The present application claims priority to, and the benefit of, U.S. Provisional Application No. 63/040,149, which was filed on Jun. 17, 2020 and is incorporated herein by reference in its entirety.

### FIELD OF THE INVENTION

The present invention relates generally to the field of social distancing-related devices. More specifically, the present invention relates to a social distancing assistance device comprising a circular barrier, which is designed to maintain proper social distancing practices in public places, and to lessen exposure to harmful airborne pathogens. The social distancing assistance device can be clipped to a hat, belt or area of the body to form a generally circular barrier around the wearer of the device. The social distancing assistance device is preferably comprised of a relatively soft foam material that ensures that the device is relatively lightweight and prevents any injury or damage in case the user accidently bumps into another person. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

During the COVID-19 pandemic it has been difficult to prevent oneself from being exposed to the harmful airborne pathogens that spread the disease. Any infectious disease may spread when individuals come in close contact with one another. Therefore, it is imperative that individuals maintain a safe distance from one other, especially in places where there are many people gathered in a relatively in a small area, to protect oneself and to slow the spread of infectious diseases, such as COVID-19.

Various health agencies have given guidelines regarding the containment and mitigation of infectious diseases. People are advised to wear protective face masks and maintain personal hygiene. Agencies have also advised people to social distance by staying at least 6 feet (about 2 arm lengths) from other people in both indoor and outdoor spaces. Social distancing is especially important in crowded public places where there is a higher risk of exposure to infected persons.

While people may try to maintain a safe distance of at least 6 feet from each other, some people may be unable to judge the 6-feet distance, and; therefore, fail to properly socially-distance themselves. Without proper distancing, people are exposed to harmful airborne pathogens and may become infected by diseases, thus endangering their own health and contributing to the spread of the infectious disease.

Therefore, there exists a long-felt need in the art for a device which enables individuals to maintain social distancing. There is also a long-felt need in the art for a device which ensures individuals keep a safe distance of 6-feet (about 2 arm lengths) from others in public places. Additionally, there is a long-felt need in the art for a wearable device which assists in social distancing to prevent individuals from coming in close contact with others. Moreover, there is a long-felt need in the art for a social distancing assistance device which enables individuals to keep a safe distance from others; therefore, preventing the spread of infectious diseases. Further, there is a long-felt need in the art for a social distancing assistance device which contributes to the containment and mitigation of pandemics such as COVID-19. Furthermore, there is a long-felt need in the art for a wearable device which is portable, can be easily worn and keeps the wearer aware of the necessary social distancing length in public places. Finally, there is a long-felt need in the art for a social distancing assistance device which can be conveniently stored and easily transported.

The subject matter disclosed and claimed herein, in one embodiment thereof, comprises a collapsible and flexible wearable social distancing device configured to be clipped to a hat, belt or other areas of the body. The social distancing device is worn on the body of a wearer and a circular barrier with a radius of up to six feet is formed around the wearer. The device includes a loop opening, a bottom circular barrier and a plurality of connecting arms attached to the loop opening and the bottom circular barrier. The loop opening is configured and dimensioned to be worn on a body part of a wearer, the bottom circular barrier is configured to create the physical circular barrier around the wearer of up to a six feet radius, and the connecting arms are configured to be taut and maintain the stability of the social distancing device when in use.

In this manner, the novel, collapsible social distancing device of the present invention accomplishes all the forgoing objectives and provides a safe, easy, and convenient solution to maintain social distancing in public places. The collapsible social distancing device of the present invention is also user friendly, as it easy to use and is also adaptable to being used in a variety of ways while also decreasing the spread of infectious diseases.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a collapsible social distancing device designed to maintain proper social distancing practices. The social distancing device creates a circular barrier having a six feet radius around a wearer of the device. The social distancing device further comprises a top circular loop and a plurality of connecting arms attaching the top circular loop and the circular barrier, the top circular loop is configured and designed to be worn on the head around a hat or around the waist of a wearer. The social distancing device is configured to collapse manually or through electronic means for easy storage when the device is not in use. During use, the device is worn by the user with the circular barrier touching the surface and having a six feet radius around the wearer to maintain a proper social distance.

In a further embodiment of the present invention, a wearable and flexible social distancing device is disclosed. The device includes a loop opening, a bottom circular barrier and a plurality of connecting arms attached to the loop opening and the bottom circular barrier. The loop opening is configured and dimensioned to be worn on a body part of a wearer, the bottom circular barrier is configured to create a physical circular barrier around the wearer of up to a six foot radius, and the connecting arms are configured to be taut, and maintain the stability of the social distancing device. During use, the social distancing device is expanded and is worn over the head or around the waist of the user to form a circular periphery of a six feet radius around the wearer to maintain a proper social distance. After use, the device is easily folded and stored in a small bag. The device is made of a flexible, soft, lightweight, foldable and affordable material such as foam.

In a further embodiment of the present invention, the collapsible social distancing device can be utilized in a variety of public settings. Based on the setting, the radius of the circular barrier can be increased or reduced to accommodate space in the setting. Because of the foam construction of the social distancing device, the device will not cause injury to persons or property that may be physically contacted by the device.

In a further embodiment of the present invention, a method for maintaining a prescribed or desired social distance to protect a user from transmission of airborne pathogens is described. The method comprises the initial step of expanding the social distancing device, next, positioning a smaller loop over head or around waist, and adjusting the circular barrier around the wearer with a desired radius placed on a surface on which the wearer is standing for maintaining social distance. During use, the radius of the circular barrier can be adjusted based on the space available. After use, the social distancing device is collapsed by folding the components of the device, and is stored in a companion or any other carry bag.

In yet a further embodiment of the present invention, a social distancing device to protect a wearer of the device from the spread of airborne pathogens is disclosed. The device comprises an upper circular loop, a bottom circular barrier, the upper circular loop and the bottom circular barrier are separated but are connected to each other through a plurality of connecting arms, the circular barrier has a radius of up to six feet around the wearer, and the upper circular loop is configured to be worn by the wearer. The circular barrier can be reduced or increase in diameter manually or through an electronic means present on the upper circular loop.

The advantage of the social distancing device of the present invention is that it allows a user to maintain proper social distancing practices in multiple ways. It can be clipped to a hat, belt or any other areas of the body to form a circular barrier around the wearer that is six feet or less. The device can be manually or electronically collapsed to accommodate for tight spaces.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of the collapsible social distancing device of the present invention in accordance with the disclosed architecture;

FIG. 2 illustrates a perspective view of one potential embodiment of the collapsible social distancing device of the present invention in accordance with the disclosed architecture, wherein the device is being worn on a hat of a user;

FIG. 3 illustrates a partial perspective and close-up view of one potential embodiment of the collapsible social distancing device of the present invention in accordance with the disclosed architecture, wherein the device is being worn on the hat of a user;

FIG. 4 illustrates a perspective view of one potential embodiment of the collapsible social distancing device of the present invention in accordance with the disclosed architecture, wherein the device is being worn on the hats or heads of a plurality of different users to maintain proper social distancing;

FIG. 5 illustrates a perspective view of one potential embodiment of the collapsible social distancing device of the present invention in accordance with the disclosed architecture, wherein the device is being worn on the waist of a plurality of different users to maintain proper social distancing; and

FIG. 6 illustrates a perspective view of one potential embodiment of a carry bag accommodating the collapsible social distancing device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. However, it is evident that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device which enables the individuals to maintain social distancing in public places. There is also a long-felt need in the art for a device which ensures the wearer keeps a safe distance of 6-feet (about 2 arm lengths) from others. Additionally, there is a long-felt need in the art for a wearable device which assists in social distancing and prevents the users from coming in close contact with others. Moreover, there is a long-felt need in the art for a social distancing assistance device which helps in maintaining a safe distance from others, thereby preventing the transmission of harmful pathogens and diminishing the spread of infectious diseases. Further, there is a long-felt need in the art for a social distancing assistance device which helps in the containment and mitigation of pandemics such as COVID-19. Furthermore, there is a long-felt need in the art for a wearable device which is portable and can be easily worn by the individuals while keeping them aware of the social distancing length. Finally, there is a long-felt need in the art for a social distancing assistance device which can be conveniently stored and transported as per the user requirements.

The present invention, in one exemplary embodiment, is a novel collapsible social distancing device designed to maintain proper social distancing practices. The social distancing device creates a circular barrier having a six feet radius around a wearer of the device. The social distancing device is comprised of a top circular loop and a plurality of connecting arms attaching the top circular loop and the circular barrier, the top circular loop is configured and designed to be worn around a hat, or on the head, waist, arm, leg, hand or any part of the wearer. When not in use, the social distancing device is configured to be collapsed manually or through electronic means. During use, the device is worn by the wearer with the circular barrier touching the surface, or elevated above the surface, and having a six feet radius around the wearer to maintain the proper social distance.

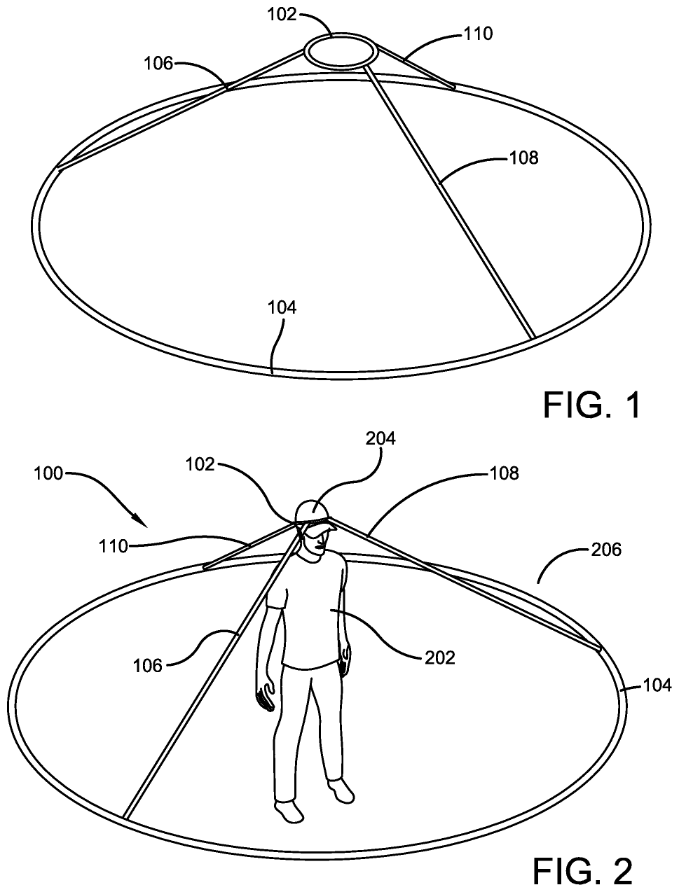

Referring to the drawings, FIG. 1 illustrates a perspective view of one potential embodiment of the collapsible social distancing device 100 of the present invention in accordance with the disclosed architecture. More specifically, the collapsible social distancing device 100 is configured to be expandable and collapsible. The social distancing device 100 can be used as a hat attachment or belt attachment and functions as a personal social distancing barrier. The social distancing device 100, when expanded for use as a personal social distancing barrier, expands uniformly with a bottom circular barrier periphery 104 having a radius of six feet and is configured to rest on a surface or be elevated above a surface when the top circular attachment periphery 102 is worn over a hat or cap, for which the top circular attachment periphery is configured and designed when using the device 100 as a personal social distancing barrier. The top circular attachment periphery 102 and the bottom circular barrier periphery 104 are connected to a plurality of taut, flexible, and extendable connecting arms 106, 108, 110. The connecting arms 106, 108, 110 maintain the radius of six feet of the bottom circular barrier periphery 104 in the extended form.

The social distancing barrier 100 is worn on a part of the body to form the six feet circular barrier around a wearer. When not in use, the social distancing barrier 100 can be easily collapsed using a mechanical and/or an electronic means. Further, the barrier 100 is made up of a soft and flexible material such as foam to prevent any injury or damage to another person who is contacted by the social distance barrier 100 of the wearer.

The social distancing device 100 is easy to carry in a bag or pouch which is commercially available with the barrier 100. The barrier 100 may come in multiple colors and sizes of the top circular attachment periphery 102. The barrier 100 allows the wearer to maintain the recommended six feet distance that is required for protection from the transmission of airborne pathogens in public spaces.

The social distancing device 100 is easy to be worn by a user and is lightweight. The weight of the device 100 resting on the wearer may be much less than the weight of the device 100 as the bottom circular barrier periphery 104 may rest on the surface upon which the wearer is standing. The barrier 100 is corrosion free, weather-proof, cost-effective and provides an effective way of maintaining the recommended six feet distance among the users. The foam construction may be supported by rubber tubing for an effective flexible construction.

In one embodiment of the present invention, the radius of the bottom circular barrier periphery 104 can be decreased to accommodate the worn barrier device 100 in smaller public spaces such as a mall. A control button on the top circular attachment periphery 102 can be used to collapse the barrier 100 and allow it to be stored in a bag or pouch.

FIG. 2 illustrates a perspective view of one potential embodiment of the collapsible social distancing device 100 of the present invention in accordance with the disclosed architecture, wherein the device 100 is being worn on the hat 204 of a user 202. More specifically, the collapsible social distancing device 100 in the present embodiment is specifically configured to be worn on the hat or cap 204 of the user 202, such that when the user or wearer 202 goes into a public setting, the social distancing device 100 expands to create a visible circular periphery, having a diameter of approximately twelve feet around the wearer 202 to maintain the required distance from other persons to reduce the potential spread of infectious diseases, such as COVID-19.

The social distancing device 100 described herein may be worn by the user 202 on a hat 204, wherein the visible bottom circular barrier periphery perimeter 104 fully extends around the user at the predetermined distance. The predetermined distance can be any desired distance, but is generally set to a distance recommended by medical personnel and/or infectious disease professionals for slowing or precluding disease transmission between individuals. For example, in some embodiments, the predetermined distance can be at least six feet. Using an electronic means, the predetermined distance can be increased or decreased as per the preferences of the wearer 202 or guidelines of health officials. The visible perimeter 104 defines a zone around the wearer 202 that other individuals should not enter if proper social distancing is to be maintained. The visible parameter 104 is connected to the top circular attachment periphery 102 which is present around the hat 204 through the connecting arms 106, 108, 110 which remain taut when the device 100 is in an extendable form. The wearer 202 may not feel the full weight of the device 100 on his or her head as the visible parameter 104 may be placed on the surface 206. The collapsible social distancing device 100 can maintain proper social distancing in open public spaces and in tightly-spaced work environments, such as in malls, shopping centers and on trading floors.

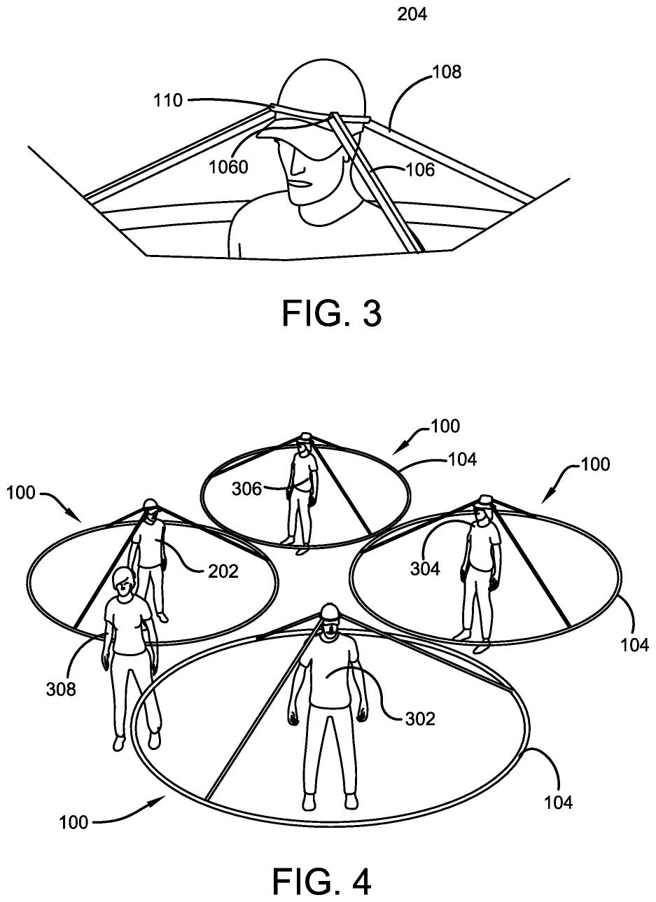

FIG. 3 illustrates a partial perspective and close-up view of one potential embodiment of the collapsible social distancing device 100 of the present invention in accordance with the disclosed architecture, wherein the device 100 is being worn on the hat of a user. More specifically, the connecting arms 106, 108, 110 connect the top circular attachment periphery 102 and the bottom circular barrier periphery perimeter 104, as best shown in FIGS. 1 and 2. Each connecting arm, such as arm 106, is attached to the top circular attachment periphery 102 via a permanent or a removable fastener 1060. Similar fasteners are used for attaching the arms 108, 110 to the top circular attachment periphery 102.

Each of the extendable connecting arms 106, 108, 110 are in the form of extendable tubes or pipes which are flexible and can collapse to reduce the length when the device 100 is not being used. The components of the social distancing device 100 can be attached to each other using adhesive or mechanical fasteners, such that the complete device 100 is foldable and collapsible into a size wherein the device can be carried in a pouch or bag.

In one embodiment, the connecting arms 106, 108, 110 are permanently attached or sewn to the top circular attachment periphery 102 and to the bottom circular periphery (not shown in FIG. 3). In an alternative embodiment, the connecting arms 106, 108, 110 may be removable from the top circular attachment periphery 102 and the bottom circular periphery.

FIG. 4 illustrates a perspective view of one potential embodiment of the collapsible social distancing device 100 of the present invention in accordance with the disclosed architecture, wherein the device 100 is being worn on the hats or heads of a plurality of different users to maintain proper social distancing. The social distancing device 100 can come in various colors and configurations and to maintain a desired social distance between individuals. As shown, a first wearer 202, a second wearer 302, a third wearer 304 and a fourth wearer 306 are wearing their own social distancing devices 100 to maintain the desired social distance. Each social distance device provides a virtual periphery 104 to prevent others from violating the minimum social distance.

A person 308 who is not wearing the social distancing device 100 of the present invention is more vulnerable to being infected by airborne pathogens as the person 308 may come into a closer proximity to an infected person who is spreading the airborne pathogens. As stated earlier, the diameter of the periphery 104 can be increased or decreased either manually or electronically using a controlling means present within the device 100 for increasing utility of the device 100.

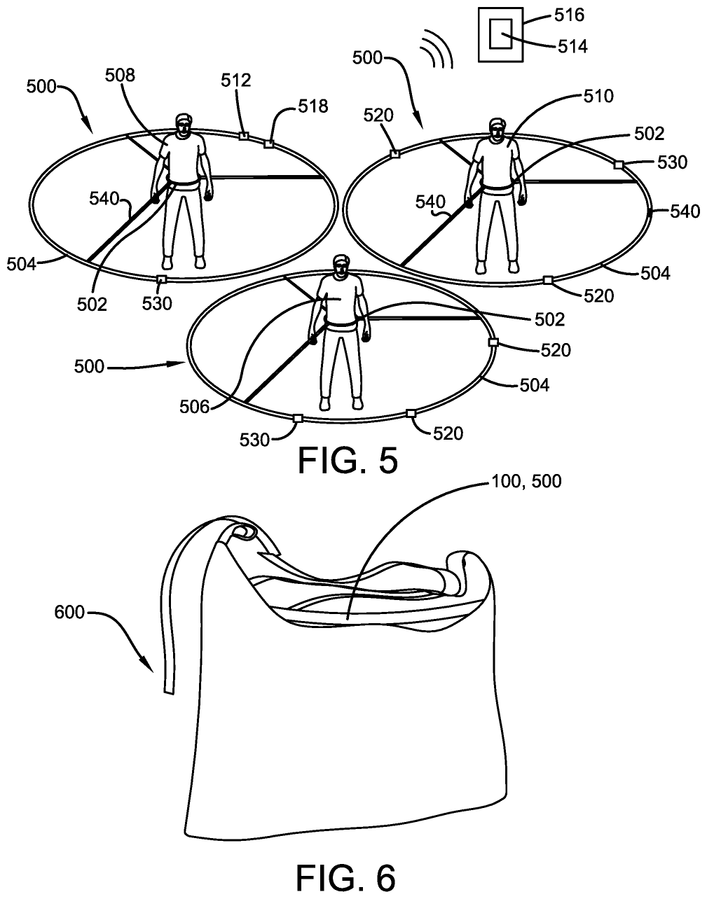

FIG. 5 illustrates a perspective view of one potential embodiment of the collapsible social distancing device 500 of the present invention in accordance with the disclosed architecture, wherein the device 500 is being worn on the waist of a plurality of different users to maintain proper social distancing. More specifically, in the present embodiment, the users 506, 508, 510 wear the social distancing device 500 configured and dimensioned to be worn over the waist in a manner similar to a belt. The social distancing device 500 has a waist cover 502 and a visible bottom circular periphery 504 which acts as a barrier for other persons, prohibiting their entering within the social distance perimeter.

Similar to the social distance devices of the other embodiments, the social distancing device 500 can be mechanically or electronically controlled to collapse and expand. The periphery 504 can have a range of up to diameter of twelve feet. The connecting arms connect the periphery 504 and the waist cover 502 in a manner similar to the connecting arms 106, 108, 110 of the social distance device 100, as best shown in FIGS. 1-3.

FIG. 6 illustrates a perspective view of one potential embodiment of a carry bag 600 for accommodating the collapsible social distancing device 100, 500 of the present invention in accordance with the disclosed architecture. The social distancing devices 100, 500 of the present invention are collapsible and can be stored in the bag 600. The foam material of the devices 100, 500 is soft and collapsed, allowing a user to carry the devices 100, 500 easily in the bag 600.

To collapse the device 100, 500, the connecting arms of the devices may be folded multiple times and the circular periphery may also be folded to a smaller diameter. The social distancing device 100, 500 of the present invention is preferably both tear-resistant and weather-proof. Additionally, the social distancing device 100, 500 is economical in cost to manufacture, relatively lightweight and portable, and is comprised of both flexible and foldable components, as described above.

The device 100, 500 of the present invention can be used by both adults and children, and can come with electronic controls as well. More specifically, in one exemplary embodiment of the present invention, the social distancing device 100, 500 may further comprise an RFID tag or other wireless communication module 512 embedded in the device 100, 500 or positioned along its various components that may be wirelessly paired with a mobile application 514 on a remote electronic device 516, as best shown in FIG. 5. The RFID tag or other wireless communication module 512 may be powered by a battery 530, and the remote electronic device 516 may be, but it not limited to, a smartphone, smart watch, computer, tablet or the like. The wireless communication module 512 may also be in communication with an electrically-wired structure within the connecting arms and the circular periphery 504, or through wireless connectivity, to collapse or expand the device 100, 500, as desired, via the mobile application 514/electronic device 516. The device 100, 500 may also have a USB or other equivalent ports 518 for purposes of charging and connectivity.

In one embodiment, the social distancing device 100, 500 of the present invention may further comprise solar-charged or battery-powered LED lights 520 to effectively illuminate the social distance perimeter at night or in other low-light situations. More specifically, the plurality of lights 520 may be positioned around the periphery 504 of the device 100, 500 in spaced-apart fashion and may be powered by a battery 530, as best shown in FIG. 5. Each of the structural components of the social distancing device 100, 500 may further comprise an anti-microbial coating 540 to further reduce the likelihood of the spread of infectious disease.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “collapsible social distancing device”, “social distancing assistance device”, “social distancing device”, “social distancing barrier”, and “device”, are interchangeable and refer to the collapsible social distancing device 100, 500 of the present invention.

Notwithstanding the forgoing, the collapsible social distancing device 100, 500 the present invention can be of any suitable size and configuration as is known in the art without affecting the overall concept of the invention, provided that it accomplishes the above-stated objectives. One of ordinary skill in the art will appreciate that the size, configuration, and material of the collapsible social distancing device 100, 500 as shown in the FIGS. are for illustrative purposes only, and that many other sizes and shapes of the collapsible social distancing device 100, 500 are well within the scope of the present disclosure. Although the dimensions of the collapsible social distancing device 100, 500 are important design parameters for user convenience, the collapsible social distancing device 100, 500 may be of any size that ensures optimal performance during use and/or that suits the user's needs and/or preferences.

Various modifications and additions can be made to the embodiments discussed herein without departing from the scope of the present invention. While the embodiments described herein refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” has been used in either the detailed description or the claims, such term is intended to be inclusive in a manner similar to the term “comprising” as “comprising” is interpreted when employed as a transitional word in a claim.

What is claimed is:

1. A social distancing device comprising:
a top circular attachment periphery removably attached to a wearer;
a bottom circular barrier periphery;
a plurality of connecting arms; and
a plurality of fasteners joining the plurality of connecting arms to each of the top circular attachment periphery and the bottom circular barrier periphery, wherein the bottom circular barrier periphery creates a social distancing barrier around the wearer.

2. The social distancing device of claim 1, wherein the top circular attachment periphery can be worn as a hat or attached to said hat.

3. The social distancing device of claim 1, wherein the top circular attachment periphery can be worn around or attached to a waist of the wearer.

4. The social distancing device of claim 1, wherein the top circular attachment periphery is adjustable in both a shape and a size.

5. The social distancing device of claim 1, wherein the bottom circular barrier periphery is expandable to form up to a six-foot radius around the wearer.

6. The social distancing device of claim 1, wherein the bottom circular barrier periphery is electronically expandable in a size via a switch on the top circular attachment periphery.

7. The social distancing device of claim 1, wherein each of the plurality of connecting arms is extendible.

8. The social distancing device of claim 1, wherein each of the plurality of fasteners is permanently joined to a select one of the plurality of connecting arms and a select one of the top circular attachment periphery or the bottom circular barrier periphery.

9. The social distancing device of claim 1, wherein each of the plurality of fasteners is detachable from a select one of the plurality of connecting arms so that the social distancing device can be disassembled.

10. The social distancing device of claim 1, wherein each of the top circular attachment periphery, the bottom circular barrier periphery an the plurality of connecting arms are comprised of a flexible and lightweight material.

11. The social distancing device of claim 1 further comprising a plurality of lights positioned along the bottom circular barrier periphery in a spaced apart fashion and powered by a battery.

12. The social distancing device of claim 11, wherein the plurality of lights are controlled by a switch located on the top circular attachment periphery, and further wherein the battery is solar charged.

13. A method of social distancing comprising:
removing an expandible social distancing device from a carrying case;
expanding a bottom circular barrier periphery of the expandible social distancing device to a first desired size;
expanding a top circular attachment periphery of the expandible social distancing device to a second desired size;
attaching a plurality of connecting arms of the expandible social distancing device to each of the bottom circular barrier periphery and the top circular attachment periphery;
extending each of the plurality of connecting arms to a desired length; and
attaching the top circular attachment periphery to a wearer or an article being worn by the wearer.

14. A social distancing system comprising:
a top circular attachment periphery that can be worn by or attached to a wearer;
a bottom circular barrier periphery;
a plurality of connecting arms;
a plurality of fasteners connecting the plurality of connecting arms to the top circular attachment periphery and the bottom circular barrier periphery, wherein the bottom circular barrier periphery creates a social distancing barrier around the wearer; and
a storage bag for storing or transporting each of the top circular attachment periphery, the bottom circular barrier periphery, the plurality of connecting arms, and the plurality of fasteners.

15. The social distancing system of claim 14, wherein the top circular attachment periphery is expandable.

16. The social distancing system of claim 15, wherein the bottom circular barrier periphery is expandable up to form a six-foot radius around the wearer.

17. The social distancing system of claim 15, wherein the bottom circular barrier periphery is electronically expandable and is controlled by a switch on the top circular attachment periphery.

18. The social distancing system of claim 17 further comprising a battery and a wireless communication module in communication with a mobile application on an electronic device, wherein each of the plurality of connecting arms is extendible via a command received from the mobile application.

19. The social distancing system of claim 18, wherein the plurality of fasteners are detachable from the plurality of connecting arms so that the social distancing system can be disassembled.

20. The social distancing system of claim 14, wherein each of the top circular attachment periphery and the bottom circular barrier periphery are comprised of a flexible and lightweight material.
